(19) United States
(12) Patent Application Publication
(10) Pub. No.: US 2024/0286944 A1
(43) Pub. Date: Aug. 29, 2024

(54) PROCESS FOR REDUCING TOTAL SUSPENDED SOLIDS (TSS), BIOCHEMICAL OXYGEN DEMAND (BOD), CHEMICAL OXYGEN DEMAND (COD) IN COMMERCIAL LAUNDRY

(71) Applicant: Ecolab USA Inc., Saint Paul, MN (US)

(72) Inventors: Kaustav Ghosh, Woodbury, MN (US); Olivia Mary Neville, Brooklyn Park, MN (US); Craig Coldiron, Saint Paul, MN (US); Russell Berman, Saint Paul, MN (US)

(21) Appl. No.: 18/589,401

(22) Filed: Feb. 27, 2024

Related U.S. Application Data
(60) Provisional application No. 63/487,109, filed on Feb. 27, 2023.

(51) Int. Cl. C02F 9/00; C02F 1/52; C02F 1/66; C02F 1/72; C02F 103/00

(52) U.S. Cl. CPC C02F 9/00; C02F 1/5245; C02F 1/66; C02F 1/725; C02F 2103/002; C02F 2209/06

(57) ABSTRACT

Methods and systems of treating textile wastewater may involve reducing the pH of the wastewater to a threshold pH range prior to adding a transition metal source and oxidizing agent to the wastewater for reducing total suspended solids (TSS), biochemical oxygen demand (BOD), and chemical oxygen demand (COD). The system design allows for optimum residence time for the chemistry to interact with wastewater effluent and remove unwanted precipitates within the wastewater source. Beneficially, the methods and systems can remove precipitates in a continuous system without the need for filtration systems.

### CROSS-REFERENCE TO RELATED APPLICATIONS

This application claims priority to U.S. Provisional Application No. 63/487,109, filed on Feb. 27, 2023, the entire contents of which are incorporated herein by reference.

### TECHNICAL FIELD

This disclosure relates to wastewater treatment systems and, more particularly, to textile wastewater treatment systems for reducing total suspended solids (TSS), biochemical oxygen demand (BOD), and/or chemical oxygen demand (COD) in a textile treatment process.

### BACKGROUND

Industries involving large amounts of wastewater discharge should have effective handling procedures in place for the treatment of domestic, commercial, and industrial wastewater. The discharge of wastewater in water sources such as rivers, lakes, and oceans can negatively impact the environment, including the spread of infectious diseases and exposure to harmful chemicals to life forms, such as aquatic life. Therefore, wastewater treatment processes have been implemented to include both sanitation of wastewater from domestic populations, as well as wastewater from industrial processes where specific pollutants in wastewater must be addressed prior to being discharged as effluent into our rivers, lakes, and oceans.

The textile industry is an example of an industry wherein large amounts of wastewater discharge are involved in the cleaning process. The wastewater discharged from the textile industry may include contaminants that must be treated prior to being released as effluent into the environment. The chemical oxygen demand (COD) and biochemical oxygen demand (BOD) are parameters that are closely monitored prior to wastewater being discharged as effluent for purposes of measuring pollutants and contaminants within the wastewater. For example, higher COD values may reflect a higher relative content of organic substances in the wastewater, which may further correspond to a higher amounts of organic substance pollution. Further, as treated wastewater will be discharged into a water source, high COD values are also a concern for aquatic life, as insufficient levels of oxygen may be available due to the high oxygen demand of the wastewater. While physical and chemical treatment methods have been considered for treating wastewater, high treatment cost and potential generation of secondary pollutants are also a limitation to utilizing current wastewater treatment methods.

### SUMMARY

In general, this disclosure is directed to wastewater treatment systems, particularly directed to wastewater from a textile commercial laundry source. The wastewater may be discharged from at least one textile washer and subsequently treated using the methods and systems described herein. The wastewater may be treated and re-used to remove total suspended solids (TSS), biochemical oxygen demand (BOD), and/or chemical oxygen demand (COD) from the water to avoid the generation of secondary pollutants and limit harm to aquatic life. In accordance with some examples of the present disclosure, the use of various treatment chemistries may be used to reduce the presence of molecules that cause COD/BOD and TSS.

In some configurations, the present disclosure provides for methods and systems that can add components such as a pH modifying agent, a transition metal source, and an oxidizing agent to the wastewater being treated. The addition of these chemical constituents can result in the formation of a precipitate, which may be subsequently separated from the wastewater in order to provide a resulting treated wastewater. In some aspects, the combination of the chemical agents administered to the wastewater allows for specific chemical reactions to take place in order to precipitate and remove organic particles in the wastewater, thereby reducing COD/BOD and TSS.

In some embodiments, the chemical constituents may be mixed in a mixing vessel. In further embodiments, the chemical constituents may be mixed in a water treatment vessel or other vessel suitable for mixing, to form the precipitate. The wastewater and precipitate may continue to flow through the system into a separator where the precipitate can be separated from the wastewater to form the treated wastewater. In some aspects, the volume of the separator may be larger than the mixing vessel or water treatment vessel in order to drop the velocity of the wastewater to aid in the precipitation of the precipitate from the wastewater.

In one example, a method of treating wastewater generated by a textile washer is described that includes receiving wastewater from at least one textile washer. A pH modifying agent is added to the wastewater to form a wastewater having an adjusted pH. A transition metal source is then added to the wastewater having the adjusted pH, in addition to an oxidizing agent being added to the wastewater having the adjusted pH. The method further includes mixing the wastewater having the adjusted pH, the transition metal source, and the oxidizing agent to form a precipitate. The precipitate is then separated from the wastewater to provide a treated wastewater.

In another example, a system for treating wastewater generated by a textile washer is described that includes one or more textile washers configured to wash textile articles and generate a wastewater. The system further includes a water treatment vessel configured to receive wastewater from one or more textile washers. One or more pumps are further fluidly connected to a pH modifying agent, a transition metal source, and an oxidizing agent so that the one or more pumps are configured to: (1) add the pH modifying agent to the wastewater in the water treatment vessel at a pH modifying agent addition location to generate a wastewater having an adjusted pH, (2) add the transition metal source to the wastewater having the adjusted pH in the water treatment vessel at a transition metal addition location, and (3) add the oxidizing agent to the wastewater having the adjusted pH in the water treatment vessel at an oxidizing agent addition location. A separator may be fluidly connected to the water treatment vessel configured to receive the wastewater and precipitate formed by the addition of the pH modifying agent, the transition metal source, and the oxidizing agent such that the separator is configured to separate the precipitate from the wastewater to provide a treated wastewater.

In another example, a wastewater treatment composition is described that includes an effective amount of a pH modifying agent to form a wastewater having an adjusted pH within a pH range of from about 4 to about 8. Further included in the composition is from about 25 ppm to about 300 ppm of a transition metal source, and from about 50 ppm to about 1000 ppm of an oxidizing agent.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example of a wastewater treatment system used to treat wastewater from one or more textile washers, the system containing a water treatment vessel, a separator, and a controller.

FIG. 2 is a block diagram illustrating a further example of a wastewater treatment system in which a water treatment vessel and additional vessels according to FIG. 3 may be implemented.

FIG. 3 is a flowchart illustrating an example mixing vessel and separator system for separating precipitates from a treated wastewater.

FIG. 4 is a graph showing the effect of various treatment formulations on COD of commercial laundry effluent across different segments of commercial laundry. The graph shows the effect of pH and time on COD.

FIG. 5 is a graph showing the effect of various oxidizing agents on COD in wastewater samples measured at various pH levels and times.

FIG. 6 is a graph showing the effect of various transition metals on COD in wastewater samples measured at different pH levels and times.

FIG. 7 is a graph showing the effects of removing colloidal particles on COD in wastewater samples at various pH levels.

FIG. 8A is a graph showing COD reduction in wastewater samples treated with iron at concentrations of 0 ppm, 50 ppm, and 100 ppm, and chlorine at concentrations of 0 ppm, 100 ppm, 200 ppm, and 400 ppm, at various pH levels.

FIG. 8B is an image of various wastewater samples, with the two most translucent samples having the greatest reduction in COD.

FIG. 9 is a graph showing the percent COD reduction in wastewater at seven different treatment facilities, each evaluating the percent COD reduction at a wastewater pH of 4.5 with 100 ppm of an iron source and varying concentrations of a chlorine source.

FIG. 10 is a graph showing the effect of various oxidizing agents on COD in wastewater samples.

### DETAILED DESCRIPTION

This disclosure is generally directed to wastewater treatment systems, including methods and techniques for controlling the addition of one or more chemical agents to a wastewater source for reducing total suspended solids (TSS), biochemical oxygen demand (BOD), and chemical oxygen demand (COD) within the wastewater. In some aspects, the wastewater is from one or more textile washers. The one or more chemical agents added to the wastewater may react with organic particles that contribute to COD/BOD within the wastewater system to reduce the COD/BOD of the final treated wastewater. This can reduce contaminants present within the wastewater discharged from the textile washers to form a treated wastewater source ready to be discharged as effluent into the environment.

While the systems and techniques according to the disclosure may be implemented for any desired wastewater treatment system, in some examples, the techniques are implemented in a system with multiple vessels. The vessels may be fluidly coupled with each other such that wastewater circulates, and may recirculate, through the vessels. One of the vessels may include a water treatment vessel into which the one or more chemical agents are added and mixed to form a precipitate. The wastewater may subsequently flow into a separator in which the precipitate is separated from the treated wastewater. In applications where the wastewater receives a pre-treatment prior to entering the water treatment vessel, a dissolved air flotation (DAF) system, or other water clarification method, may be utilized to pre-treat the wastewater.

In some examples, the wastewater flowing through the treatment system is pH adjusted with a pH adjusting agent prior to receiving additional chemical agents. The sensor may be used to measure the pH of the wastewater within the water treatment vessel, where a controller is connected to the sensor and controls the addition of the pH adjusting agent according to the pH measured by the sensor. The controller may further control the addition of additional chemical agents once a target pH range has been reached. The maintenance of a target pH range can aid in the formation of precipitates for reducing COD/BOD of the wastewater.

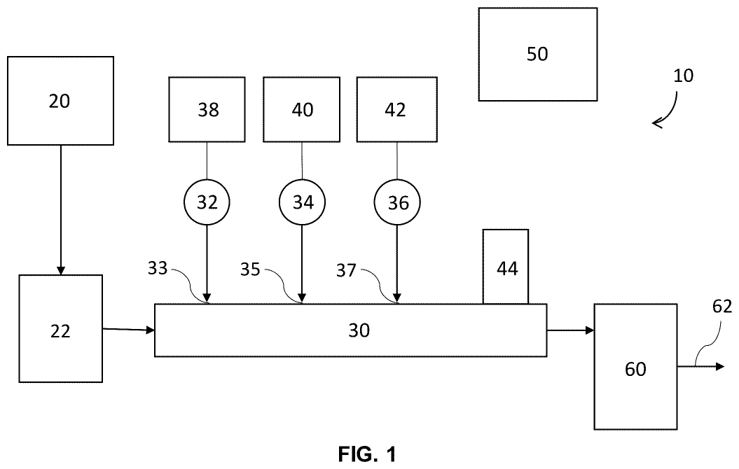

FIG. 1 is a block diagram illustrating an example water treatment system 10 used to treat wastewater generated from one or more wastewater sources. Example water treatment system 10 includes one or more textile washers 20 configured to wash textile articles. The one or more textile washers 20 may be fluidly connected to a water treatment vessel 30. As will be further described herein, pumps 32, 34, and 36 draw chemical agents from treatment source one 38, treatment source two 40, and treatment source three 42 respectively at a suction side of the pumps, pressurizing the chemical agents inside of the pumps, and discharging the chemical agents at an elevated pressure into the water treatment vessel 30. Water treatment vessel 30 is further connected to a sensor 44 which measures the pH of the wastewater within the water treatment vessel 30.

System 10 in FIG. 1 also includes a controller 50 for managing the wastewater treatment system. The controller 50 can receive data from the sensor 44, where the data can provide information concerning the pH of the wastewater inside the water treatment vessel 30 such that the controller 50 adjusts the amount of one or more chemical agents from treatment sources one, two, and three (38, 40, 42) to be added to the water treatment vessel 30. Once the chemical agents from treatment sources one, two, and three (38, 40, 42) are pumped into water treatment vessel 30 via the pumps (32, 34, 36), wastewater may be mixed with the chemical agents within water treatment vessel 30 to form a precipitate. As water treatment vessel 30 may be fluidly connected to separator 60, the wastewater with precipitate can flow into separator 60 and separate into its precipitate and treated wastewater components.

As one example, FIG. 1 shows one or more textile washers 20 which are configured to wash textile articles. The one or more textile washers 20 generate wastewater, which can be treated in the water treatment system 10. While wastewater from any textile washer may be treated, in some embodiments, the wastewater may be discharged from a textile washer in commercial laundry systems. In some aspects, liquid within textile washers have been found, in some applications, to be the source of unwanted solid materials and various chemical contaminants which need to be removed prior to the wastewater being discharged as effluent into the environment. These solid materials and various chemical contaminants may include, but are not limited to, dirt, sand, lint, other sheared textile material, detergent products, and other chemical additives which may contribute to increased COD/BOD within the wastewater. Accordingly, example water treatment system configurations are described below with reference to an example textile wastewater source in which the water treatment system 10 may be implemented to reduce COD/BOD and TSS within the wastewater. It should be appreciated, however, that the disclosure is not limited in this respect unless otherwise noted, and a water treatment system can be used in other wastewater treatment applications.

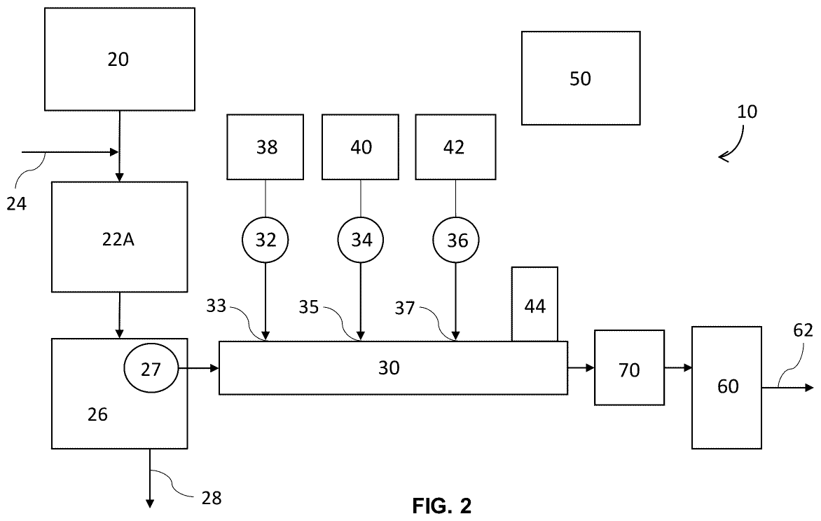

The water treatment system 10 in the example of FIG. 1 may optionally include a pre-treatment system 22. The optional pre-treatment system 22 may be fluidly connected to the one or more textile washers 20 in order to receive wastewater from the one or more textile washers. As will be described in greater detail below with respect to FIG. 2, the pre-treatment system 22 may include any water treatment system for purposes of clarifying the wastewater prior to being discharged as effluent. Suitable pre-treatment systems are designed to remove suspended soils, fats, greases, oils, and non-soluble organics from a wastewater stream. The various pre-treatment systems may include, but are not limited to, a dissolved air flotation (DAF) system, aerobic treatment system, or induced gas flotation system. In some embodiments, the pre-treatment system may include filtration methods, including, but not limited to, ceramic microfiltration (CMF) and spinning disc filtration (or rotating disc filtration) where large particulates may be filtered out of the wastewater. In other embodiments, no pre-treatment is required. In some embodiments, the pre-treatment system 22 is a DAF system.

When the pre-treatment system 22 is optional and not included in the water treatment system 10, the wastewater from the one or more textile washers 20 may be placed in fluid communication with the water treatment vessel 30. In embodiments where the pre-treatment system 22 is included in the water treatment system 10, the wastewater discharged from the pre-treatment system 22 may flow directly to the water treatment vessel 30. Therefore, the water treatment vessel 30 may receive wastewater that has been pre-treated by the pre-treatment system 22, or has come directly from the one or more textile washers 20. In some configurations, the water treatment vessel 30 may include, but not limited to, a fluid conduit comprising a pipe or segment of tubing that allows fluid to be conveyed from one location to another location in the system. For example, the water treatment vessel 30 may be a fluid inline pipe, a fluid line provided by a section of housing and/or fluid conduit, a tank, or other housing unit to receive the wastewater to be treated. The material used to fabricate the water treatment vessel 30 should be chemically compatible with the wastewater to be conveyed, and in various examples, may be steel, stainless steel, or a polymer (i.e., polypropylene, polyethylene, polyvinylidene difluoride, etc.). In example embodiments, the water treatment vessel 30 may be situated between the one or more washers 20 and separator 60, with optional pre-treatment system 22 provided between the one or more washers 20 and water treatment vessel 30.

Depending on the configuration of the water treatment vessel 30, the water treatment vessel may have one or more existing ports, valve connections, or pumps that can be used to fluidly couple chemical agents to the water treatment vessel 30. During operation of the system 10, chemical agents from treatment source one 38, treatment source two 40, and treatment source three 42 may be conveyed to the water treatment vessel 30 via pumps 32, 34, and 36 respectively. During operation of the system 10, pump 32 may operate to transfer product from treatment source one 38 to the water treatment vessel 30 until, for example, the treatment source one 38 is empty and/or the wastewater within the water treatment vessel 30 is full with a desired amount of treatment source one 38. Pump 34 may operate to transfer product from treatment source two 40 to the water treatment vessel 30 until, for example, the treatment source two 40 is empty and/or the wastewater within the water treatment vessel 30 is full with a desired amount of treatment source two 40. Pump 36 may operate to transfer product from treatment source three 42 to the water treatment vessel 30 until, for example, the treatment source three 42 is empty and/or the wastewater within the water treatment vessel 30 is full with a desired amount of treatment source three 42.

In some examples, the product in treatment source one 38 is a pH modifying agent. Because the wastewater received within the water treatment vessel 30 is typically highly alkaline due to the detergents present within the textile wastewater, the pH modifying agent may beneficially be a pH decreasing agent. The pH modifying agent may comprise any source of acid for purposes of decreasing the pH of the wastewater received within the water treatment vessel 30. The acid may include a weak acid, a strong acid, or a combination of a weak acid and a strong acid. Strong acids that can be used are acids which substantially dissociate in an aqueous solution. Weak organic and inorganic acids are acids or acid components in which the first dissociation step of a proton from the acid moiety does not proceed essentially to completion when the acid is dissolved in water at ambient temperatures at a concentration within the range useful to reduce the pH of the wastewater. Exemplary strong acids suitable for use in the compositions may include methane sulfonic acid, sulfuric acid, sodium hydrogen sulfate, phosphoric acid, phosphonic acid, nitric acid, sulfamic acid, hydrochloric acid, trichloroacetic acid, trifluoroacetic acid, toluene sulfonic acid, glutamic acid, and the like; alkane sulfonic acid, such as methane sulfonic acid, ethane sulfonic acid, linear alkyl benzene sulfonic acid, xylene sulfonic acid, cumene sulfonic acid and the like. In some aspects, the compositions include a strong acid having a pKa less than about 2.5. Exemplary weak acids suitable for use in the compositions including alpha hydroxycarboxylic acid, such as lactic acid, citric acid, tartaric acid, malic acid, gluconic acid, and the like; carboxylic acids, such as formic acid, acetic acid, propionic acid and the like; other common organic acids such as ascorbic acid, glutamic acid, levulinic acid, etc. may also be used. In some aspects, the weak acid may have a pKa greater than about 2.5.

During operation, the pH modifying agent of treatment source one 38 is added to the wastewater within water treatment vessel 30 at a pH modifying agent addition location 33 to form a wastewater having an adjusted pH. In some examples, the pH range of the incoming wastewater from the one or more textile washers may be in the range of between about 7 and about 14, between about 8 and about 13, between about 9 and about 12, or between about 9.5 and 11.5. In some aspects, an effective amount of the pH modifying agent of treatment source one 38 is added to the wastewater at the pH modifying agent addition location 33 to form the wastewater having the adjusted pH. The adjusted pH range may have a threshold pH range of between about 3 and about 8, between about 4 and about 8, or between about 4.5 and about 7. After addition of the pH modifying agent to form the wastewater having an adjusted pH, the pH of the wastewater is measured at a location typically downstream from the location at which the pH modifying agent is added to the wastewater. The measured pH at the downstream location is compared to the threshold pH range so that the addition of the pH modifying agent can be controlled based on the comparison of the measured pH to the threshold pH. If the measured pH is greater than the upper limit of the threshold pH range, additional pH modifying agent can be added in intervals or continuously to the wastewater within the water treatment vessel 30. Alternatively, if the measured pH is less than the lower limit of the threshold pH range, the addition of the pH modifying agent containing a pH decreasing agent is paused or stopped until the measured pH is back within the threshold pH range or above. If the measured pH is within range of the threshold pH range, the pH modifying agent may continue to be added to the wastewater in intervals or continuously until the measured pH is less than the lower range of the threshold pH range. Alternatively, if the measured pH is within range of the threshold pH range, the addition of the pH modifying agent may also be paused or stopped until the measured pH is above the upper limit of the threshold pH range.

As illustrated in FIG. 1, in some examples, the product in treatment source two 40 is a transition metal source. In preferred embodiments, the transition metal source is added to the wastewater already having the adjusted pH as described herein. In some embodiments, the transition metal source refers to a component comprising a transition metal, i.e., any element contained within the d-block on the periodic table, i.e., groups 3 through 12 on the periodic table. Exemplary transition metals suitable for use as the transition metal source include, but are not limited to, iron, copper, manganese, derivatives and salts thereof, and combinations thereof. The transition metal source is the source of the transition metal ions, including ions having various oxidation states. For example, the transition metal source may include sources of Fe²⁺, Fe³⁺, Cu⁺, Cu²⁺, Mn²⁺, Mn³⁺, Mn⁴⁺, Mn⁶⁺, Mn⁷⁺, salts thereof, and combinations thereof. While the transition metal source is not limited to salts of the transition metal ions, suitable transition metal sources for use in the system 10 include, but are not limited to, ferrous salts, including ferrous chloride, ferrous sulfate, ferrous fumarate, and ferrous gluconate, copper salts, and manganese salts.

During operation of the system 10, the transition metal source of the treatment source two 40 is added to the wastewater having the adjusted pH within water treatment vessel 30 at a transition metal source addition location 35. As briefly mentioned above, pump 34 conveys the transition metal source of the treatment source two 40 to the water treatment vessel 30 at the transition metal source addition location 35. In some examples, the concentration of transition metal source added may result in an amount of between about 25 ppm and about 300 ppm, between about 30 ppm and about 275 ppm, or between about 50 ppm and about 200 ppm of the transition metal ion. In further examples, the concentration of transition metal source added results in at least 100 ppm of transition metal ion in the wastewater having the adjusted pH.

As further illustrated in FIG. 1, in some examples, the product in treatment source three 42 is an oxidizing agent. In preferred embodiments, the oxidizing agent is added to the wastewater already having the adjusted pH as described herein. In some embodiments, the oxidizing agent may comprise peroxides, peroxide donors, perborates, percarbonates, peroxycarboxylic acids, bleaching agents, such as hypochlorites, chlorides, chlorinated phosphates, chloroisocyanates, chloramines, and combinations thereof. Suitable bleaching agents include those that liberate an active halogen species such as chlorine, bromine, hypochlorite ion, and hypobromide ion, under conditions normally encountered in typical cleaning processes. The active halogen compound can, for example, be a source of a free elemental halogen or —OX— wherein X is Cl or Br, under conditions normally used in detergent-bleaching cleaning processes. In embodiments, the active halogen compound releases chlorine or bromine species. In further embodiments, the active halogen compound releases chlorine.

Chlorine releasing compounds include potassium dichloroisocyanurate, sodium dichloroisocyanurate, chlorinated trisodiumphosphate, sodium hypochlorite, calcium hypochlorite, lithium hypochlorite, monochloramine, dichloroamine, [(monotrichloro)-tetra(monopotassium dichloro)]pentaisocyanurate, paratoluene sulfondichloro-amide, trichloromelamine, N-chlorammeline, N-chlorosuccinimide, N,N′-dichloroazodicarbonamide, N-chloro-acetyl-urea, N,N′-dichlorobiuret, chlorinated dicyandiamide, trichlorocyanuric acid, dichloroglycoluril, 1,3-dichloro-5,5-dimethyl hydantoin, 1-3-dichloro-5-ethyl-5-methyl hydantoin, 1-choro-3-bromo-5-ethyl-5-methyl hydantoin, dichlorohydantoin, trichloromelamine, sulfondichloroamide, trichlorocyanuric acid, salts or hydrates thereof, and mixtures thereof. In embodiments, a chlorine releasing compound includes sodium hypochlorite. In further embodiments, an organic chlorine releasing compound can be sufficiently soluble in water to have a hydrolysis constant (K) of about 10⁻⁴ or greater. A bleaching agent may also include an agent containing or acting as a source of active oxygen. The active oxygen compound acts to provide a source of active oxygen, for example, may release active oxygen in aqueous solutions. An active oxygen compound can be inorganic, organic, or can be a mixture thereof. Some examples of active oxygen compound include peroxygen compounds, or peroxygen compound adducts. Some examples of active oxygen compounds or sources include hydrogen peroxide, perborates, sodium carbonate, and the like. However, in further embodiments, the oxidizing agent of treatment source three 42 is not hydrogen peroxide. In further embodiments, the oxidizing agent of treatment source three 42 is not a peroxycarboxylic acid. In some examples, the concentration of oxidizing agent added may result in an amount of between about 50 ppm and about 1000 ppm, between about 75 ppm and about 900 ppm, or between about 100 ppm and about 800 ppm of the oxidizing agent in the wastewater having the adjusted pH.

During operation of the system 10, the oxidizing agent of the treatment source three 42 is added to the wastewater having the adjusted pH within water treatment vessel 30 at an oxidizing agent addition location 37. As briefly mentioned above, pump 36 conveys the oxidizing agent of the treatment source three 42 to the water treatment vessel 30 at the oxidizing agent addition location 37. In embodiments, adding the oxidizing agent to the wastewater having the adjusted pH comprises adding the oxidizing agent at an oxidizing agent addition location 37 that is downstream of the transition metal source addition location 35 at which the transition metal source 40 is added to the wastewater having the adjusted pH. As the wastewater having the adjusted pH has already received the pH modifying agent from treatment source one 38, both of the transition metal source addition location 35 and oxidizing agent addition location 37 are located downstream from the pH modifying agent addition location 33.

When treating the wastewater with the pH modifying agent, transition metal source, and oxidizing agent, the addition of each of the components comprises adding the pH modifying agent, adding the transition metal source, and adding the oxidizing agent to a flowing stream of the wastewater. In other embodiments, the addition of each of the components comprises mixing the wastewater having the pH adjusted pH, the transition metal source, and the oxidizing agent while flowing inline. In embodiments, the pH modifying agent, transition metal source, and oxidizing agent contact the wastewater within a water treatment vessel 30. After the wastewater has received the pH modifying agent, the transition metal source, and the oxidizing agent, the components may be mixed within the water treatment vessel 30. While the water treatment vessel 30 is not limited to any particular configuration, shape, or size, the treatment vessel must be configured so as to allow for sufficient residence time of the wastewater treated with the pH modifying agent, the transition metal source, and the oxidizing agent within the water treatment vessel 30 to complete its chemical processes. This includes varying the angle of the incoming liquid entering the water treatment vessel 30 so as to allow optimum mixing of the components within the water treatment vessel. As will be further described herein under FIG. 2, more than one vessel may be used to ensure sufficient residence time and mixing of the wastewater having the adjusted pH, the transition metal source, and the oxidizing agent.

In embodiments, the wastewater having the adjusted pH, the transition metal source, and the oxidizing agent are mixed for a period of time between about 5 minutes and about 50 minutes, between about 10 minutes and 45 minutes, or between about 10 minutes and 30 minutes. In further embodiments, the period of time may be at least about 5 minutes, at least about 10 minutes, or at least about 15 minutes, including, but not limited to, at least 1 hour, at least 2 hours, at least 3 hours, or at least 4 hours. In embodiments wherein the water treatment system 10 is continuous, the wastewater having the adjusted pH, the transition metal source, and the oxidizing agent are mixed for a period of about 45 minutes or less, about 40 minutes or less, about 30 minutes or less, or about 15 minutes or less. During the process of mixing, a precipitate will form within the wastewater being treated. In some aspects, the precipitate may be further referred to as “sludge.” The combination of chemical agents administered to the wastewater allows for specific chemical reactions to take place in order to precipitate and remove organic particles in the wastewater, thereby reducing COD/BOD and TSS.

As illustrated in FIG. 1, system 10 containing the water treatment vessel 30 is further shown to include a sensor 44 positioned to measure the wastewater within the water treatment vessel 30. The sensor 44 comprises a pH sensor configured to analyze the pH of the wastewater passing through water treatment vessel 30. The sensor 44 may be implemented in a number of different ways in system 10. In some embodiments, the sensor may be positioned adjacent to the water treatment vessel 30 or the sensor may be position in line with wastewater flowing through the water treatment vessel 30. Additional configurations may be contemplated as long as the sensor 44 is positioned to measure the pH of the wastewater. In some aspects, the sensor 44 is measuring the wastewater having the adjusted pH in the water treatment vessel 30, where the sensor 44 is located at a position downstream from the pH modifying agent addition location 33. Data generated by sensor 44 and/or otherwise associated with the wastewater under evaluation can be received by controller 50, e.g., for storage in memory and/or further processing.

With further reference to FIG. 1, controller 50 can manage the overall operation of system 10. Controller 50 may be communicatively coupled to various components within system 10, for example, via a wired or wireless connection, so as to send and receive electronic control signals and information between controller 50 and the communicatively coupled components. For example, controller 50 may control pumps 32, 34, and 36 to manage the addition of the chemical agents from each of treatment source one 38, treatment source two 40, and treatment source three 42 respectively into the water treatment vessel 30. The controller 50 can also control sensor 44 to analyze the pH of the wastewater within the water treatment vessel 30. Upon controller 50 receiving a signal from sensor 44 indicating that the property of the wastewater has been measured, the controller can control the discharge of each of treatment source one 38, treatment source two 40, and treatment source three 42 into the water treatment vessel 30. To do this, controller 50 may control the pumps 32, 34, and 46 by controlling a power source that drives movement of the system 10.

For example, during the operation of system 10, sensor 44 may send a message to controller 50 requesting that the pH modifying agent be transferred from treatment source one 38 to the water treatment vessel 30 provided the data gathered by the sensor 44. The controller 50 may activate pump 32 to draw pH modifying agent from the treatment source one 38 and push pressurized product into water treatment vessel 30. Pump 32 may continuously pump product from treatment source one 38 until a suitable amount of product has been transferred. This may occur when the treatment source one 38 is substantially or entirely empty. This may occur when a desired amount of product has been added to the water treatment vessel 30. Controller 50 may stop pump 32 after transferring a suitable amount of the pH modifying agent from treatment source one 38 to the water treatment vessel 30. Within this example, sensor 44 and controller 50 work together to determine when to continue or stop the addition of pH modifying agent to the water treatment vessel 30. The measured pH of the wastewater having an adjusted pH as measured by the sensor 44 is compared to a threshold pH range so that the addition of the pH modifying agent can be controlled based on the comparison of the measured pH to the threshold pH. If the measured pH is greater than the upper limit of the threshold pH range, additional pH modifying agent can be added in intervals or continuously to the wastewater within the water treatment vessel 30. Alternatively, if the measured pH is less than the lower limit of the threshold pH range, the addition of the pH modifying agent containing a pH decreasing agent is paused or stopped until the measured pH is back within the threshold pH range or above. If the measured pH is within range of the threshold pH range, the pH modifying agent may continue to be added to the wastewater in intervals or continuously until the measured pH is less than the lower range of the threshold pH range. Alternatively, if the measured pH is within range of the threshold pH range, the addition of the pH modifying agent may also be paused or stopped until the measured pH is above the upper limit of the threshold pH range.

The techniques described in this disclosure, including functions performed by a controller, control unit, or control system, may be implemented within one or more of a general-purpose microprocessor, digital signal processor (DSP), application specific integrated circuit (ASIC), field programmable gate array (FPGA), programmable logic devices (PLDs), or other equivalent logic devices. Accordingly, the terms “processor” or “controller,” as used herein, may refer to any one or more of the foregoing structures or any other structure suitable for implementation of the techniques described herein.

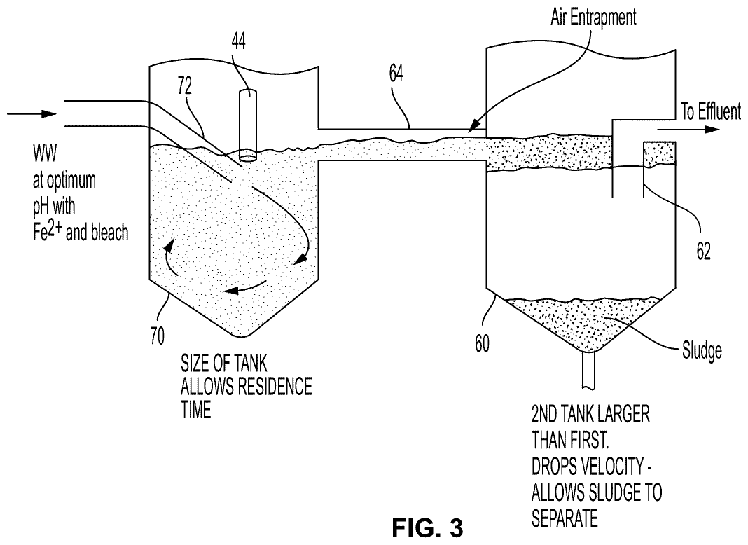

With further reference to FIG. 1, once the wastewater having an adjusted pH, transition metal source, and oxidizing agent are mixed for a predetermined period of time to from a precipitate, the wastewater and precipitate continue to flow through the system 10 into a separator 60, which will be described in further detail below regarding FIG. 3. Separator 60 operates to receive the wastewater and precipitate from the water treatment vessel 30 to separate the precipitate from the wastewater to provide a treated wastewater. Separator 60 comprises a separation vessel configured to separate the precipitate from the treated wastewater. In some aspects, the separation vessel may be a tank, such as, but not limited to a conical tank. In other aspects, the separation vessel may be a flow tube with weir design to remove and separate precipitate from a wastewater source. Once the precipitate is separated, the treated wastewater may be discharged as effluent into the environment via discharge port 62. While not shown in FIG. 1, in some embodiments, the pH of the final outgoing wastewater may be further modified either after the precipitation is formed and before separating the precipitate from the wastewater, or after separating the precipitate form the wastewater. In some aspects, the pH of the final outgoing wastewater may be modified to comply with local municipal laws and regulations. In some examples, the pH of the final outgoing wastewater may be adjusted to a pH greater than about 6, or greater than about 7. Further, the system 10 may optionally include administering a flocculator to the separator 60 to improve flocculation and precipitate quality. For example, the flocculator may comprise a polymer. In some embodiments, the flocculator comprises an acrylic acid based anionic high molecular weight latex polymer. In aspects, the flocculator may be Effluent Care™ 6931A.

While the treated wastewater is being discharged from separator 60 via discharge port 62, the precipitate separated from the treated wastewater source may build-up within separator 60 in batch form and cleaned periodically. Alternatively, the precipitate may be drawn off continuously via piping, and removing the precipitate from separator 60.

In a process of cleaning system 10, in general, flushing liquid may be a fluid that functions to flush equipment within system 10 and displaces chemical agents from treatment source one 38, treatment source two 40, and treatment source three 42, remaining in the equipment of system 10. This can help recover residual product trapped within the process equipment by pushing it to a downstream location and also prepare the equipment to process a subsequent batch of fluid. Flushing liquid can be any liquid having a different composition than that of the treatment source (38, 40, 42). In one example, flushing fluid is water (e.g., may consist, or consist essentially of, water). When the flushing fluid is water, the water may be supplied as fresh water from a pressurized water main or other suitable source. In other examples, flushing liquid may contain other components suitable for cleaning the equipment within the system 10.

FIG. 2 is a block diagram illustrating another configuration of the water treatment system 10 described in FIG. 1, however, further incorporating a Dissolved Air Flotation (DAF) system 22A as the pre-treatment system, an optional effluent pit 26 with pump 27 positioned between the DAF system 22A and water treatment vessel 30, and a mixing vessel 70 positioned between the water treatment vessel 30 and separator 60.

As one example, FIG. 2 shows the inclusion of a pre-treatment system 22A in fluid connection with the one or more textile washers 20. In embodiments, the pre-treatment system 22A is a dissolved air flotation (DAF) system and receives wastewater discharged from the one or more textile washers 20. DAF systems may treat the wastewater by dissolving air in the wastewater under pressure and releasing the air at atmospheric pressure in a floatation tank. The released air forms tiny bubbles which adhere to suspended matter or flocculated particles, causing the suspended matter or flocculated particles to float to the surface of the water where it can then be separated from the wastewater for proper disposal. In embodiments, additional chemical agents, including, but not limited to flocculating agents, may be added to the DAF system 22A via port line 24. The addition of additional chemical agents may be done in-line or in a separate vessel upstream of the DAF. The addition of additional chemical agents may aid in suspending unwanted solids and colloidal particles from clumping together. Once the wastewater is treated in the DAF system, the wastewater may proceed to flow into water treatment vessel 30 as described herein and as described above with regard to FIG. 1.

Alternatively, once the wastewater is treated in the DAF system, the wastewater may proceed through an optional effluent pit 26 with pump 27. Wastewater within the effluent pit 26 may be pumped throughout the system 10 using a submersible pump 27. As pump 27 has a maximum flow rate, some wastewater discharged from the DAF system 22A may not be treated upon entering the effluent pit 26 and will instead be discharged as effluent into the environment via the discharge line for effluent 28. While the wastewater being discharged immediately through the discharge line for effluent 28 may not be treated, the majority of wastewater discharged from the one or more washers will be pumped through to the water treatment vessel 30.

The wastewater will proceed through system 10 and water treatment vessel 30 as described above with regard to FIG. 1. However, FIG. 2 further illustrates a mixing vessel 70 situated between the water treatment vessel 30 and separator 60. In embodiments, while the treatment sources (38, 40, and 42) may begin to interact within the water treatment vessel 30, wastewater having the adjusted pH, the transition metal source, and oxidizing agent are subsequently introduced into mixing vessel 70 and mixed together. Similar to the disclosures provided above with regard to mixing times in the water treatment vessel 30, similar embodiments may apply to mixing vessel 70. In embodiments, the wastewater having the adjusted pH, the transition metal source, and the oxidizing agent are mixed for a period of time between about 5 minutes and about 50 minutes, between about 10 minutes and 45 minutes, or between about 10 minutes and 30 minutes. In further embodiments, the period of time may be at least about 5 minutes, at least about 10 minutes, or at least about 15 minutes. In embodiments wherein the water treatment system 10 is continuous, the wastewater having the adjusted pH, the transition metal source, and the oxidizing agent are mixed for a period of about 45 minutes or less, about 40 minutes or less, about 30 minutes or less, or about 15 minutes or less. During the process of mixing, a precipitate will form within the wastewater being treated. In some aspects, the precipitate may be further referred to as “sludge.” The combination of chemical agents administered to the wastewater allows for specific chemical reactions to take place in order to precipitate and remove organic particles in the wastewater, thereby reducing COD/BOD and TSS.

FIG. 3 is a flow chart illustrating an example operation of mixing vessel 70 into separator 60. In embodiments where mixing vessel 70 is present, sensor 44 may be instead positioned to measure a property of the wastewater in the mixing vessel 70 instead of the water treatment vessel 30 as described in FIGS. 1 and 2. The property measured may vary, however, will include at least one sensor for measuring the pH of the wastewater within mixing vessel 70. The mixing vessel beneficially assists in mixing the wastewater adjusted with pH, transition metal source, and oxidizing agent, not only by facilitating mixing by the angle of the incoming water tubing 72 within the mixing vessel 70, but also by the size and shape of the mixing vessel 70. The angle is created to allow optimum mixing within the mixing vessel. Further, the size of the mixing vessel may be configured to allow at least 15 minutes of residence time in the mixing vessel 70 in order for the wastewater having an adjusted pH, transition metal source, and oxidizing agent to chemically react and form a precipitate within the wastewater. The wastewater from the mixing vessel 70 is subsequently fed into separator 60, wherein the precipitate will be separated from the wastewater to form a treated wastewater.

While many different separation methods may be utilized in the systems of the present disclosure, FIG. 3 illustrates an example of separation accomplished by gravity. When receiving the wastewater from the mixing vessel 70 to the separator 60, the wastewater flowed through tubing 64 configured in a manner to allow air entrapment as the wastewater is fed into the separator 60. In some aspects, the volume of the separator 60 may also be larger than the mixing vessel 70 in order to drop the velocity of the wastewater. For example, for a mixing vessel 70 having a size of 1600 gallons, the separator 60 may have a size of 3200 gallons. Due to the drop in velocity, the precipitate separates out from the wastewater due to gravity and either floats to the surface, or sinks to the bottom. To achieve this separation, the precipitate formed by the wastewater and three treatment sources (38, 40, 42) comprises a first precipitate having a density less than the treated wastewater, and a second precipitate having a density greater than the treated water. The precipitate is separated from the wastewater to provide a treated wastewater, where the separating comprises gravity separating the first precipitate and the second precipitate from the treated wastewater. The treated wastewater may be drawn out from the separator 60 from an intermediate layer between the first precipitate and the second precipitate in the separator 60. With regard to the precipitate, the precipitate may be drawn off continuously via piping, or the precipitate may be left to build up in the separator 60, with periodic cleaning of the equipment found within system 10.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components.

The techniques described in this disclosure may also be embodied or encoded in a computer-readable medium, such as a non-transitory computer-readable storage medium, containing instructions. Instructions embedded or encoded in a computer-readable storage medium may cause a programmable processor, or other processor, to perform the method, e.g., when the instructions are executed. Non-transitory computer readable storage media may include volatile and/or non-volatile memory forms including, e.g., random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

The following examples may provide additional details about wastewater treatment systems, methods, and techniques for reducing COD/BOD and TSS according to the disclosure.

### EXAMPLES

Embodiments of the present disclosure are further defined in the following non-limiting Examples. It should be understood that these Examples, while indicating certain embodiments of the disclosure, are given by way of illustration only. From the above discussion and these Examples, one skilled in the art can ascertain the essential characteristics of this disclosure, and without departing from the spirit and scope thereof, can make various changes and modifications of the embodiments of the disclosure to adapt it to various usages and conditions. Thus, various modifications of the embodiments of the disclosure, in addition to those shown and described herein, will be apparent to those skilled in the art from the foregoing description. Such modifications are also intended to fall within the scope of the appended claims.

### Example 1

### Effect of Treatment Compositions Across Different Segments of Commercial Laundry

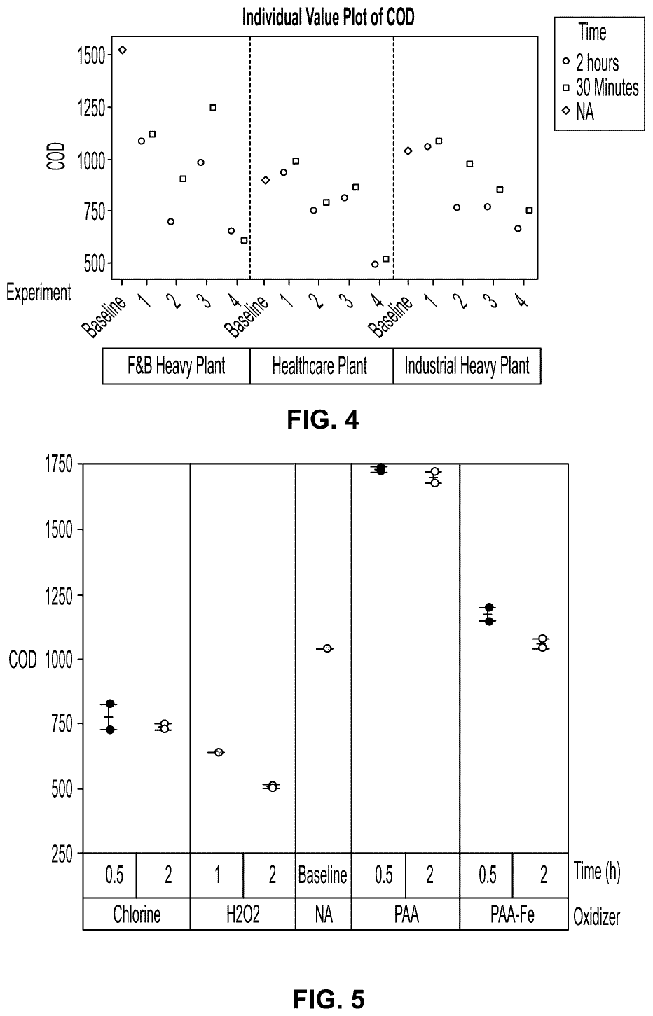

Various experimental formulations containing an oxidizing agent and transition metal source were evaluated for its effects on lowering the COD value of commercial laundry/textile effluent across different segments of commercial laundry. Within the present example, 100 mL of wastewater from different segments of commercial laundry were evaluated, included textile effluent from (1) a food and beverage plant; (2) a healthcare plant; and (3) an industrial plant. The various experimental formulations included the four formulations as shown below in Table 1. The oxidizing agent utilized for all of the formulations was hydrogen peroxide, and the transition metal source utilized for all the formulations was ferrous chloride. The pH of each formulation is provided within Table 1. For formulations with no pH adjustment, the pH was simply the pH of the wastewater effluent from a commercial laundry source. This pH with no adjustment was in the range of about 9.5 to about 11.5. A plot graph of the COD values for each of the four formulations in each of the segments of commercial laundry were collected at times 0 minutes, 30 minutes, and 2 hours. The results are shown in FIG. 4.

TABLE 1

| Formulation | Hydrogen Peroxide | Ferrous Chloride | |
|---|---|---|---|
| No. | (ppm) | (ppm of Fe²⁺) | pH |
| 1 | 400 | 50 | No pH adjustment |
| 2 | 400 | 50 | 5 |
| 3 | 400 | 100 | No pH adjustment |
| 4 | 400 | 100 | 5 |

For Formulation Nos. 2 and 4, the pH of the wastewater was first taken to a desired value through addition of some acid (sulfuric acid, commonly used). To that formulation, ferrous chloride was added to a desired ppm under stirring. The concentration of ferrous was confirmed through titration. Next, an oxidizer was added to a desired ppm under stirring. Titration was used to confirm the concentration. Once the oxidizer addition is complete, the process/residence time starts, and once the process time is complete, the stirring is stopped, and solution kept at rest for >4 hours. The clear decanter from the top of the solution is sampled and COD for the top solution is measured and reported.

As demonstrated in FIG. 4, the inclusion of hydrogen peroxide and ferrous chloride lowered COD for wastewater across all segments of the commercial laundry evaluated. Further, pH was a significant factor in further reducing the COD. As shown in FIG. 4, formulations 2 and 4 generally provided lower COD values compared to formulations 1 and 3 respectively at both 30 minutes and 2 hours. Even further, residence time was also a factor in lowering the COD value across all segments of commercial laundry. As shown within FIG. 4, the COD at 2 hours generally provided lower values than at 30 minutes.

### Example 2

### Comparison of Various Oxidizing Agents

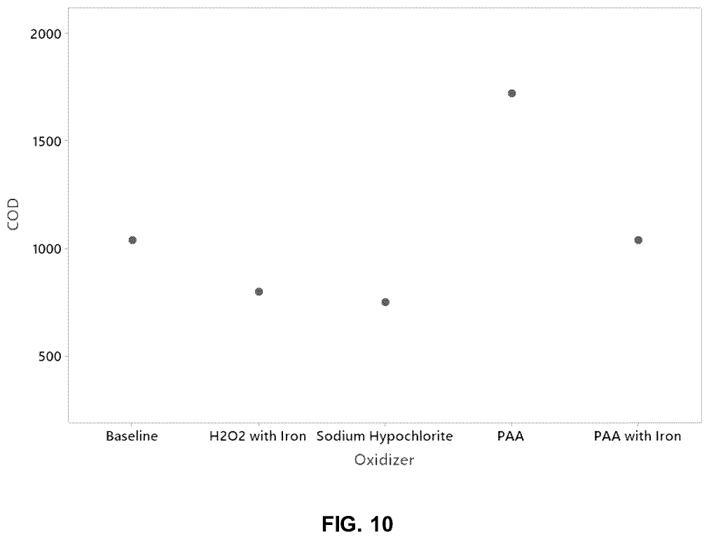

Various oxidizing agents in addition to hydrogen peroxide with iron were evaluated for their effects on COD reduction. Various formulations were evaluated and with a plot graph of the results shown in FIG. 5. The formulations evaluated in FIG. 5 included sodium hypochlorite (Chlorine), hydrogen peroxide (H₂O₂), peroxyacetic acid (PAA), and peroxyacetic acid with iron (PAA-Fe). The COD was evaluated at various times as indicated in FIG. 5. In a further exemplary example, various formulations as shown in Table 2 were evaluated for their effects on COD reduction. The various oxidizing agents evaluated included hydrogen peroxide with iron (H₂O₂ with iron), sodium hypochlorite (chlorine bleach), peroxyacetic acid (PAA), peroxyacetic acid with iron (PAA with iron). The oxidizing agents were further included at varying concentrations, including 200 ppm and 800 ppm. The source of Fe2+ used was ferrous chloride. A plot graph of the COD values for the oxidizing agents in Table 2 can be found in FIG. 10. The methods utilized for measuring COD were similar to those provided in Example 1.

TABLE 2

| Oxidizing | Oxidizing | Fe²⁺ | Time | Temperature |
|---|---|---|---|---|
| Agent | Agent ppm | (ppm) | (hr) | (° C.) |
| H₂O₂ with Iron | 800 | 50 | 2 | 35 |
| Sodium | 800 | 0 | 2 | 35 |
| Hypochlorite | | | | |
| PAA | 200 | 0 | 2 | 35 |
| PAA with Iron | 200 | 50 | 2 | 35 |

As demonstrated within FIG. 10, the organic peroxides such as PAA did not appear to be effective in reducing COD, although addition of a transition metal source such as iron was able to reduce COD with the PAA. Further, sodium hypochlorite was able to provide comparable COD reduction to that of H₂O₂, demonstrating its efficacy as an oxidizing agent for the present methods and systems.

### Example 3

### Comparison of Various Transition Metal Sources

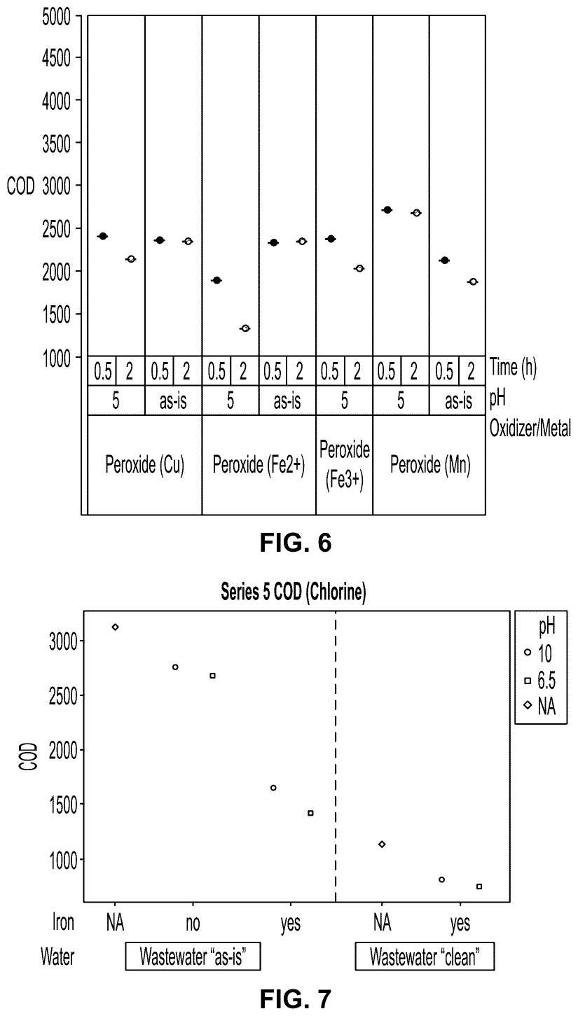

A variety of transition metal sources were further evaluated for their efficacy on reducing COD in textile wastewater. The transitional metals evaluated included copper (II) ion (Cu²⁺), iron (II) ion (Fe²⁺), iron (III) ion (Fe³⁺), and manganese (II) ion (Mn²⁺). The chloride salt form was used for the transition metal sources. The oxidizing agent utilized was hydrogen peroxide for each of the formulations evaluated. The results are shown in FIG. 6. As shown within FIG. 6, the pH of the formulations were either not adjusted (shown as “as is”; around a pH of about 9.5 to about 11.5) or adjusted to a pH of about 5. The COD was evaluated after 0.5 hours or after 2 hours for each formulation. For purposes of a comparison, the baseline COD for the treatment group was around 3000 ppm.

As shown within FIG. 6, all transition metals demonstrated the ability reduce COD from baseline. The formulation with Fe²⁺ was the most effective in reducing COD at the lower pH level. While not shown in FIG. 6, similar trends were also observed using chlorine bleach as the oxidizing agent instead of hydrogen peroxide.

### Example 4

### Evaluation of Colloidal Particles on COD

Evaluation of the impact of colloidal particles within a wastewater source on COD was completed to help determine possible mechanisms of reducing COD utilizing a combination treatment with a transition metal source and oxidizing agent. Results of the evaluation can be found in FIG. 7. As shown in FIG. 7, the left side of the graph shows the COD value for wastewater samples at baseline, at pH of 6.5 and 10 with treatment of ferrous chloride but no chlorine bleach treatment, and at pH 6.5 and 10 with a treatment of both chlorine bleach and ferrous chloride. The results demonstrate that treatment with a transition metal source and oxidizing agent lowers COD significantly from baseline, compared to a wastewater source treated with only ferrous chloride. Without being limited to any particular mechanism or theory, the combination of a transition metal source and oxidizing agent are effective at reducing COD by creating a precipitate (or sludge) with the colloidal organic particles that contribute to COD, and reaction with soluble organic particles that contribute to COD.

In furtherance of this theory, a second study was completed to determine the effects of colloidal particles on COD. As shown in FIG. 7, the right side of the graph provides the results of COD after the wastewater samples were sent through a filtration system to remove any colloidal particles from wastewater. The results demonstrate that removing the colloidal particles from the wastewater significantly reduced COD, including a significant reduction at baseline. In viewing FIG. 7 as a whole, it can be seen that COD is decreased for both samples, i.e., wastewater “as-is” (with colloidal particles remaining in the sample), versus wastewater “clean” (with colloidal particles removed), while utilizing the chlorine and ferrous treatment system. However, the greater percent reduction can be observed for the as-is wastewater sample. As demonstrated by the results, and without being limited to any particular mechanism of action, it is contemplated that, in some embodiments, the chlorine and ferrous treatment system is likely reducing COD by precipitating out colloidal organic particles from the wastewater.

### Example 5

### Effects of Residence Time on COD Reduction

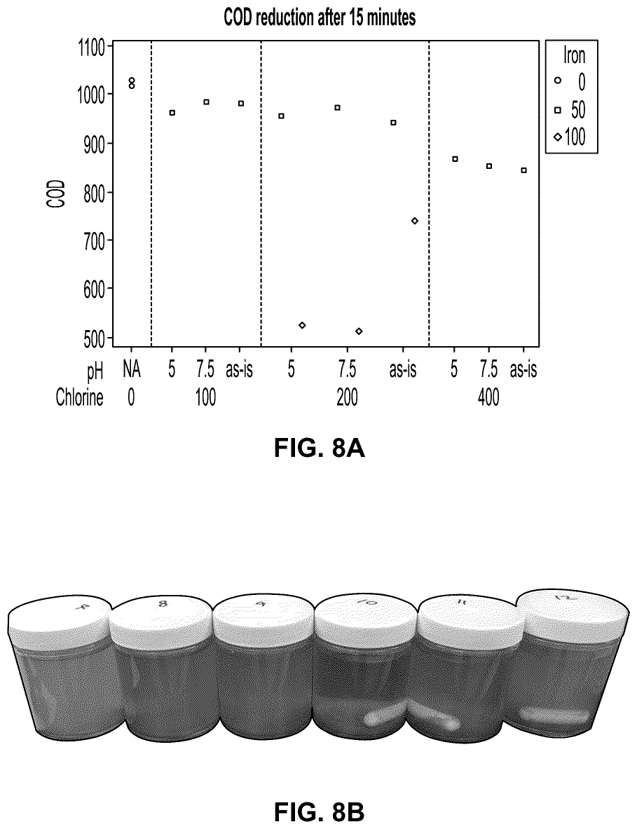

In continuous process systems, such as those implemented in actual commercial laundering, systems need to be designed for short residence times in order to keep system costs low. Preferably, the residence time should be about 15 minutes or lower. A comparison of COD reduction of various wastewater samples with iron concentrations of 0 ppm, 50 ppm, and 100 ppm, chlorine concentrations of 0 ppm, 100 ppm, 200 ppm, and 400 ppm, were evaluated at various pH levels. The results can be found in FIG. 8A and FIG. 8B. As shown in FIG. 8A, wastewater treated with at least 100 ppm of iron was important in reducing COD with a residence time of 15 minutes. In FIG. 8B, wastewater samples 10 and 11 correspond with the two data points with the lowest COD shown in FIG. 8A. As can be seen in FIG. 8B, at least in the present Example, the greater the reduction in COD, the more translucent the treated wastewater.

### Example 6

### Assessment of COD at Fixed pH and Iron Levels

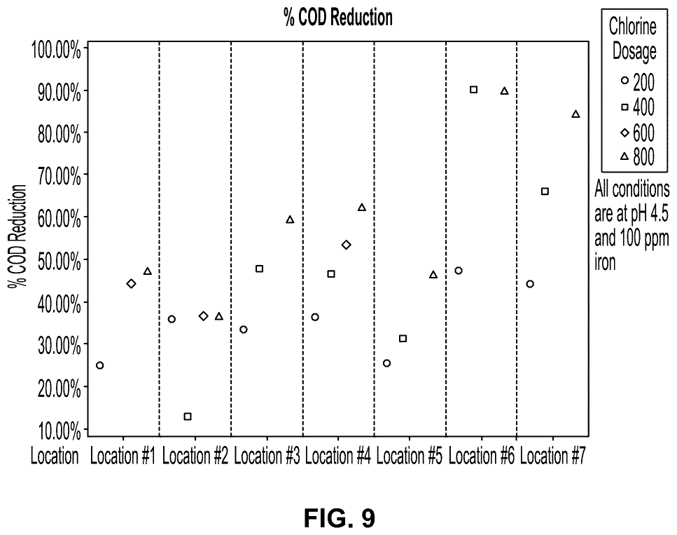

The percent COD reduction was evaluated at fixed pH and iron levels. The pH level was fixed at 4.5 with the addition of 100 ppm of an iron source. The concentration of chlorine bleach varied between 200 ppm, 400 ppm, 600 ppm, and 800 ppm. Various treatment formulations were evaluated at seven different commercial laundry plants. The results are shown in FIG. 9. As shown in FIG. 9, the treatment systems with about 100 ppm of an iron source and various concentrations of a chlorine source at a target pH of 4.5 provided between about 25% to 90% reduction in COD across multiple commercial laundry plants.

### Example 7

### Correlation of COD and BOD Reduction

An additional study was conducted to demonstrate the correlation between the results observed for COD reduction and BOD reduction. Wastewater samples from two textile care locations were treated with 200 pm of chlorine bleach and 200 ppm of an iron source at a pH of 5.5 for a residence time of 1 hour. Both COD and BOD values were measured at baseline and post-treatment with the chlorine and iron treatment system. The methods utilized for measuring BOD were very similar to the methods utilized to measure COD provided in Example 1, except due to the higher water volume need of BOD sampling, the process was started with 1.5 L of the wastewater sample, instead of only 100 mL. The results are shown below in Table 3.

TABLE 3

| Location No. | Treatment | COD (ppm) | BOD (ppm) |
|---|---|---|---|
| 1 | Baseline | 1350 | 582 |
| | Chlorine/ | 913 | <100 |
| | Fe²⁺ | | |
| 2 | Baseline | 3840 | 1640 |
| | Chlorine/ | 2140 | 806 |
| | Fe²⁺ | | |

As shown within Table 3, both COD and BOD values were reduced with the chlorine and iron treatment system. The results demonstrated that COD reduction achieved through the treatment system was further associated with a corresponding BOD reduction.

Various examples have been described. These and other examples are within the scope of the following claims.

What is claimed is:

1. A method of treating wastewater generated by a textile washer, the method comprising:
receiving wastewater discharged from at least one textile washer;
adding a pH modifying agent to the wastewater to form a wastewater having an adjusted pH;
adding a transition metal source to the wastewater having the adjusted pH;
adding an oxidizing agent to the wastewater having the adjusted pH;
mixing the wastewater having the adjusted pH, the transition metal source, and the oxidizing agent to form a precipitate; and
separating the precipitate from the wastewater to provide a treated wastewater.

2. The method of claim 1, wherein the pH modifying agent is a pH decreasing agent comprising a source of acid.

3. The method of claim 1, wherein incoming wastewater has a pH of between about 9 and about 12, and adding the pH modifying agent comprises adding an effective amount of the pH modifying agent to form the wastewater having the adjusted pH within a pH range of from about 4 to about 8.

4. The method of claim 1, further comprising:
measuring the pH of the wastewater having the adjusted pH downstream of a location at which the pH modifying agent is added to provide a measured pH;
comparing the measured pH to a threshold pH; and
controlling addition of the pH modifying agent based on comparison of the measured pH to the threshold pH.

5. The method of claim 1, wherein adding the oxidizing agent to the wastewater having the adjusted pH comprises adding the oxidizing agent at an oxidizing agent addition location downstream of a transition metal source addition location at which the transition metal source is added to the wastewater having the adjusted pH.

6. The method of claim 1, wherein the transition metal source is added to the wastewater having the adjusted pH at a concentration of between about 25 ppm and 300 ppm of the transition metal ion.

7. The method of claim 1, wherein the oxidizing agent is added to the wastewater having the adjusted pH at a concentration of between about 50 ppm and 1000 ppm.

8. The method of claim 1, wherein adding the pH modifying agent, adding the transition metal source, and adding the oxidizing agent to the wastewater comprises adding the pH modifying agent, adding the transition metal source, and adding the oxidizing agent to a flowing stream of the wastewater.

9. The method of claim 1, wherein mixing the wastewater having the adjusted pH, the transition metal source, and the oxidizing agent comprises mixing the wastewater having the adjusted pH, the transition metal source, and the oxidizing agent while flowing inline.

10. The method of claim 1, wherein mixing the wastewater having the adjusted pH, the transition metal source, and the oxidizing agent comprises:
introducing the wastewater having the adjusted pH, the transition metal source, and the oxidizing agent into a mixing vessel and mixing the wastewater having the adjusted pH, the transition metal, and the oxidizing agent in the mixing vessel.

11. The method of claim 1, wherein the wastewater having the adjusted pH, the transition metal source, and the oxidizing agent is mixed for a period of time between about 5 minutes and about 45 minutes.

12. The method of claim 1, further comprising a step of modifying the pH of the wastewater to a pH greater than about 6 either after the precipitate is formed and before separating the precipitate from the wastewater, or after separating the precipitate from the wastewater.

13. The method of claim 1, wherein separating the precipitate from the wastewater to provide the treated wastewater comprises gravity separating the precipitate from the wastewater.

14. The method of claim 1, wherein:
mixing the wastewater having the adjusted pH, the transition metal source, and the oxidizing agent to form the precipitate comprises forming a first precipitate having a density less than the treated wastewater and a second precipitate having a density greater than the treated wastewater; and
wherein the separating comprises gravity separating the first precipitate and the second precipitate from the treated wastewater in a separator and drawing the treated wastewater from an intermediate layer between the first precipitate and the second precipitate in the separator.

15. The method of claim 1, wherein receiving wastewater discharged from at least one textile washer comprises:
generating the wastewater by the at least one textile washer;
introducing a flocculant into the wastewater; and
processing the wastewater in a dissolved air floatation float tank in which flocculated particles are separated from the wastewater.

16. A system for treating wastewater generated by a textile washer, the system comprising:
one or more textile washers configured to wash textile articles and generate a wastewater;
a water treatment vessel configured to receive the wastewater from the one or more textile washers;
one or more pumps fluidly connected to a pH modifying agent, a transition metal source, and an oxidizing agent, wherein the one or more pumps are configured to: (1) add the pH modifying agent to the wastewater in the water treatment vessel at a pH modifying agent addition location to generate a wastewater having an adjusted pH, (2) add the transition metal source to the wastewater having the adjusted pH in the water treatment vessel at a transition metal addition location, and (3) add the oxidizing agent to the wastewater having the adjusted pH in the water treatment vessel at an oxidizing agent addition location; and
a separator fluidly connected to the water treatment vessel configured to receive the wastewater and precipitate formed by addition of the pH modifying agent, the transition metal source, and the oxidizing agent, wherein the separator is configured to separate the precipitate from the wastewater to provide a treated wastewater.

17. The system of claim 16, further comprising a mixing vessel fluidly connected to the water treatment vessel and configured to receive the wastewater comprising the pH modifying agent, the transition metal source, and the oxidizing agent, and mixing the wastewater comprising the pH modifying agent, the transition metal source, and the oxidizing agent to generate the precipitate.

18. The system of claim 16, further comprising:
a pH sensor positioned to measure a pH of the wastewater having the adjusted pH in the water treatment vessel;
a controller communicatively connected to the pH sensor and the one or more pumps, wherein the controller is configured to:
receive a measured pH of the wastewater having the adjusted pH from the pH sensor;
compare the measured pH to a threshold pH; and
control the one or more pumps to control addition of the pH modifying agent based on comparison of measured pH to the threshold pH.

19. The system of claim 16, wherein the one or more pumps comprises a first pump connected to the pH modifying agent, a second pump connected to the transition metal source, and a third pump connected to the oxidizing agent.

20. The system of claim 19, wherein the second pump is at a location downstream from the first pump, and wherein third pump is at a location downstream from the second pump.

21. The system of claim 16, wherein the separator comprises a separation vessel configured to gravity separate the precipitate from the treated wastewater, wherein the precipitate comprises a first precipitate having a density less than the treated wastewater and a second precipitate having a density greater than the treated wastewater.

22. The system of claim 16, further comprising a dissolved air flotation float tank for receiving the wastewater from the one or more textile washers prior to discharging the wastewater into the water treatment vessel.

23. A wastewater treatment composition comprising:
an effective amount of a pH modifying agent to form a wastewater having an adjusted pH within a pH range of from about 4 to about 8;
from about 25 ppm to about 300 ppm of a transition metal source; and
from about 50 ppm to about 1000 ppm of an oxidizing agent.

24. The composition of claim 23, wherein the oxidizing agent is not hydrogen peroxide.

25. The composition of claim 23, wherein the transition metal source comprises iron.
